(19) United States
(12) Patent Application Publication
(10) Pub. No.: US 2010/0200268 A1
(43) Pub. Date: Aug. 12, 2010

(54) FOAMED RESIN COMPOSITION AND WIRE/CABLE USING THE SAME

(75) Inventors: Hideyuki SUZUKI, Hitachi (JP); Masahiro Abe, Hitachi (JP); Akinari Nakayama, Hitachinaka (JP); Kazunori Suzuki, Hitachi (JP); Tatsuya Sasamura, Hitachi (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 12/702,620

(22) Filed: Feb. 9, 2010

(30) Foreign Application Priority Data
Feb. 10, 2009 (JP) 2009-028633

(51) Int. Cl. H01B 3/30; C08L 23/06; C08L 23/12

(52) U.S. Cl. 174/110 SR; 521/134

(57) ABSTRACT

A foamed resin composition includes a polyolefin-based resin, and a ring opening polymer of norbornene or a copolymer of norbornene and ethylene or a mixture thereof. The ring opening polymer of norbornene or the copolymer of norbornene and ethylene or the mixture thereof is used as a foam nucleating agent in the foamed resin composition.

The present application is based on Japanese Patent Application No. 2009-028633 filed on Feb. 10, 2009, the entire contents of which are incorporated herein by reference.

### BACKGROUND OF THE INVENTION

1. Field of the Invention

The invention relates to a foamed resin composition and a wire/cable using the same.

2. Description of the Related Art

In accordance with development of information network in recent years, a high speed and large capacity wire is required for transmitting information. Particularly nowadays, an apparatus adopting a method in which positive and negative voltages are applied to a two-core cable, so-called differential transmission, is increasing.

The differential transmission system has a problem that, although resistance to external noise is high, it is hard to control a signal transmission time difference (i.e., delay time difference or skew) between two wires.

The skew is a difference in delay time between individual wires, and since it is determined by permittivity of insulator of the wire, it is most important to control the foaming rate of the insulator. In other words, an excellent cable with small skew has extremely small variation in the foaming rate between respective wires.

In general, as a foaming method of insulator, there are a method using a chemical foaming agent (chemical foaming) as described in JP-A 11-189743 and JP-A-11-514680, and a method of foaming using a pressure difference between inside and outside of a forming machine by injecting a gas into a molten resin in the forming machine (physical foaming) as described in JP-A 2000-297172, JP-A 2000-3111519, JP-A 2005-271504 and JP-A-2008-500702.

The chemical foaming has an advantage in that the insulator with less variation in the foaming rate is easily obtained, however, there is a problem that it is difficult to achieve high foaming rate and that the permittivity of the insulator is large in contrast to the foaming rate since the permittivity of a foaming agent residue is often large.

Therefore, an expanded insulation manufactured by the physical foaming method is often used in a cable which is used for high speed differential transmission.

As described above, since the delay time difference is determined by the permittivity of the insulator, an insulator with high foaming rate is essential for a high speed transmission cable, and the foaming rate needs to be uniform for performing differential transmission. In addition, the insulator with high foaming rate generally has less resin content and tends to be lack of mechanical strength, thus, there is a problem such that crushing or buckling is easily generated, or the like.

Although there is a method in which a structure of cable jacket, etc., is strengthened for preventing such problems, a method of maintaining the most stable performance should be to miniaturize air bubble itself and to disperse loading or stress. Namely, an ideal cable is a cable having large amount of microscopic and uniform air bubbles without (with less) variation in the foaming rate over the entire length. In order to obtain such a cable, each manufacturing company is working on developing foaming resin compositions, foaming conditions and manufacturing devices.

In order to maintain the foaming rate while miniaturizing the air bubble, it is necessary to generate a large amount of air bubbles and also a selection of foam nucleating agent is important. Optimal composition and shape of the nucleating agent are different depending on a base resin or forming conditions, however, it is basically known that the number of the added particle significantly increases with diminishing particle size even if the added amount is the same, and the number of the generated air bubbles thereby increases.

Here, the problem arises that the nucleating agent of the fine particle itself is likely to be aggregated and it is thus very difficult to uniformly disperse in the resin. Namely, the fine particle is aggregated when being added in the resin, and it adversely affects the variation in the foaming rate and, in an extreme case, physical properties of the resin composition itself.

Such a dispersion problem is generally treated by making a master batch (MB) of the nucleating agent. In other words, it is a method in which the MB having a high concentration nucleating agent mixed in a resin is made using an apparatus dedicated for kneading and the MB is diluted in a wire forming machine (a foam extruder), for preventing an extreme dispersion defect.

However, although a dispersion state can be improved by this method in a certain degree, the material needs to be processed in multiple steps and the problem such as an increase in material (processing) cost or change in material physical properties due to processing history is likely to occur.

In addition, there is a problem in a large amount addition of the nucleating agent for the same reason. Since the nucleating agent is basically foreign substance, the large amount addition adversely affects the physical properties of the resin composition itself, and the advantage as the foam is likely to be lost.

For example, it is known to use non-heterocyclic polyolefin based resin as a foam nucleating agent (JP-A-2008-500702). However, all nucleating agents of non-heterocyclic polyolefin-based resin as disclosed in the above-mentioned JP-A-2008-500702 (Poly4-methylpentene-1; TPX, etc.) has a melting point (melting point of 220-240° C.) higher than that of polyethylene, and an extrusion temperature when using the TPX is 265-290° C. Therefore, in a low temperature process for manufacturing a blend of polyethylene generally used in the foamed resin composition, there is a possibility that the particle of the nucleating agent is not dissolved and remains without change.

### SUMMARY OF THE INVENTION

It is an object of the invention to provide a foamed resin composition that high foaming and microscopic air bubble can be stably realized at the same time by an easy method and the nucleating agent generates a large number of air bubbles allowing the high foaming and stability of the foaming rate compatible with a mechanical strength even by an easy addition method with a small amount, and also to provide a foam insulated wire/cable using a high speed transmission expanded insulation with small skew and excellent mechanical strength.
(1) According to one embodiment of the invention, a foamed resin composition comprises:

a polyolefin-based resin; and

a ring opening polymer of norbornene or a copolymer of norbornene and ethylene or a mixture thereof,

wherein the ring opening polymer of norbornene or the copolymer of norbornene and ethylene or the mixture thereof is used as a foam nucleating agent.

In the above embodiment (1), the following modifications and changes can be made.

(i) The polyolefin-based resin comprises polyethylene or polypropylene or a mixture thereof.

(ii) 0.001-1 mass % of the ring opening polymer of norbornene or the copolymer of ethylene or the mixture thereof is contained per 100 mass % of the foamed resin composition.
(2) According to another embodiment of the invention, a foamed insulated wire or cable comprises:

the foamed resin composition according to the embodiment (1) as an expanded insulation on an outer periphery of a metal conductor.

### Points of the Invention

According to one embodiment of the invention is a pellet form norbornene-based resin added to polyolefin exists as a fine particle, is dispersed in the polyolefin by kneading and shearing in a forming machine (a foam extruder), and functions as a nucleating agent.

In other words, a large amount of nucleating agent particles can be uniformly dispersed into the resin to obtain a further uniform foam without arising problems such as a dispersion defect generated when initially intended to add fine particles or a variation in physical property when a large amount of nucleating agent is added.

By using the norbornene-based resin that is processable at a low temperature, the norbornene-based resin can be dissolved and dispersed as a nucleating agent into a resin of which process temperature is low (e.g., a blend containing PE).

As a result, the stability of the foaming rate is improved, and it is possible to manufacture a foam insulated wire/cable with higher foaming, lower skew and more excellent mechanical strength than a foam insulated wire using a conventional foam nucleating agent.

### BRIEF DESCRIPTION OF THE DRAWINGS

Next, the present invention will be explained in more detail in conjunction with appended drawings, wherein:

FIG. 1 is a cross sectional view showing a foam insulated wire of the invention; and

FIG. 2 is a cross sectional view showing a foam insulated wire/cable of the invention.

### DESCRIPTION OF THE PREFERRED EMBODIMENTS

A preferred embodiment of the invention will be explained in detail hereinafter in conjunction with appended drawings.

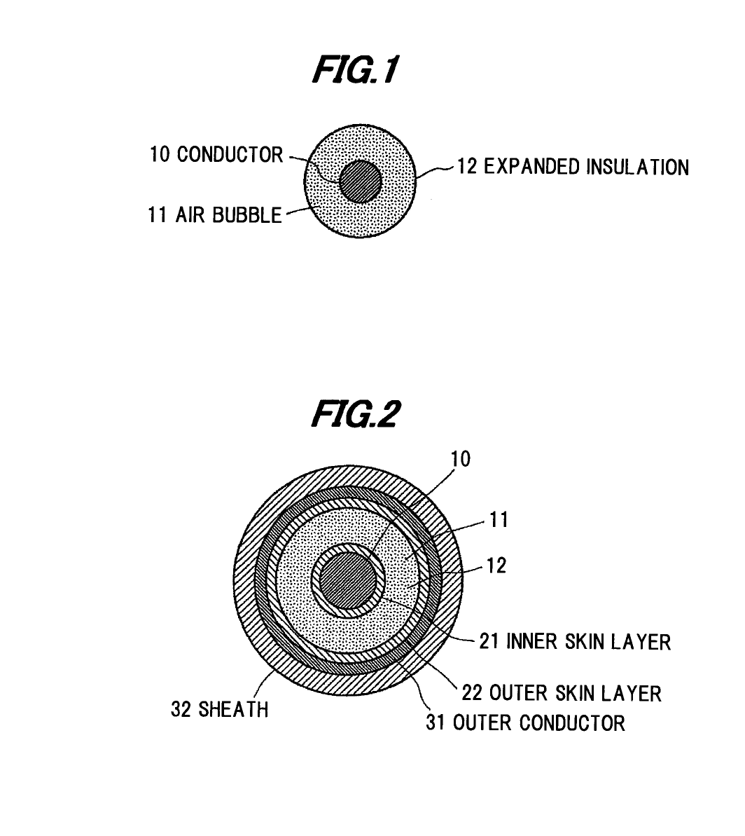

Firstly, as shown in FIG. 1, a foam insulated wire of the invention is formed by coating a conductor 10 with an expanded insulation 12 which is extruded thereon and has numerous air bubbles (or pores) 11.

Alternatively, there may be a modification of the wire structure other than the shaped shown in FIG. 1.

FIG. 2 shows a modification.

FIG. 2 shows a foam insulated wire/cable formed by coating the outer surface of the conductor 10 with an inner skin layer 21, extrusion-molding the expanded insulation 12 on the outer periphery thereof, coating the outer periphery thereof with an outer skin layer 22, and then, forming an outer conductor 31 on the outer periphery of the outer skin layer 22 and forming a sheath 32.

The conductor 10 may be a single or stranded wire, and it is possible to use various types of alloy wires or, a tube conductor according to the circumstances, other than a copper wire.

The expanded insulation 12 containing the air bubbles 11 may be a single layer or a combination of plural foam layers. In addition, coating layers 21 and 22, which are not foaming as a skin layer or have an extremely small foaming rate in comparison with the expanded insulation 12, are formed on inner and outer peripheries of the expanded insulation 12.

In addition, a spiral or braid of extra fine metal wire or wrapping of the metal foil can be arbitrarily selected for forming the outer conductor 31 on the outer periphery of the expanded insulation 12 or the outer skin layer 22 depending on the intended used and necessary performance.

For a material of the sheath 32 to be formed on further outside of the outer conductor 31, an arbitrary material such as polyolefin which are PE or PP, etc., fluorine resin or vinyl chloride can be used.

Regardless of the presence of the outer conductor 31, it is possible to arbitrarily select a configuration as a foam insulated wire. For example, the structure is arbitrary such that a method of using one foam insulated wire by providing an outer conductor and a sheath layer outside thereof is used, or plural foam insulated wires are twisted or arranged in parallel and, depending on the necessity, a drain wire (an earth wire) is sealed.

The expanded insulation 12 shown in the FIGS. 1 and 2 is formed of a polyolefin-based polyethylene or polypropylene resin as a main material, and is formed by adding less than 1 mass % of a ring opening polymer of norbornene, or a copolymer of norbornene and ethylene, which are norbornene-based resins, or a mixture thereof, as a nucleating agent.

More specifically, the expanded insulation 12 is formed of:

60-95 mass % of high density polyethylene (HDPE),

5-40 mass % of low density polyethylene (LDPE), and

0.001-1 mass % of norbornene-based resin,

with respect to the total amount of the resin.

The added amount of the norbornene resin used for the invention is 0.001-1 mass % with respect to the total resin composition, and preferably 0.01-1 mass %.

An effect as a nucleating agent is insufficient when the added amount is too little, which leads to the coarsening of air bubble and an increase in variation in the foaming rate. In addition, when the added amount is excessive, the air bubble also becomes large and a problem of a decrease in stability of the foaming rate is likely to arise. Likewise, it is not possible to ignore variation in resin properties due to the excessive addition. For example, flexibility (ease of bending), which is a characteristic of the polyolefin-based foamed resin composition, may be impaired.

The resin used in the invention is mainly polyolefin resin, which indicates polyethylene (PE) or polypropylene (PP).

PE includes ultra high molecular weight PE, high density PE, medium density PE, low density PE and linear low density PE, which can be used independently or in combination of plural types thereof.

Meanwhile, PP includes homopolymer, random copolymer which is a copolymer with ethylene, and a block copolymer, which can be used independently or in combination of plural types thereof.

In addition, a colorant, an antioxidant, a viscosity modifier or other additives, which can be added for the application of electrical insulation, can be added to the above-mentioned resins.

A norbornene-based resin added as a foam nucleating agent is made of a ring opening polymer of norbornene, or a copolymer of norbornene and ethylene, or a mixture thereof, and is typified by ZEONEX and ZEONOR which are ring opening polymer systems (both are manufactured by Zeon Corporation) and TOPAS (manufactured by Polyplastics Co., Ltd.) which is an ethylene copolymer system, however, similar compounds other than the above can be used.

Unlike TPX (polymethylpentene) in JP-A-2008-500702, TOPAS is amorphous and has characteristics that the glass transition temperature is 80-180° C. and the extrusion temperature is also a low temperature of 220-240° C.

As a method of adding the above resins, besides a dry blending method in which a pellet or powder resin is introduced into a foam extruder with another polyolefin resin, it is possible to adopt a method in which a resin composition premixed in the polyolefin resin at a high concentration is used as a master batch.

It is contemplated that, by kneading with the polyolefin resin in the foam extruder or a kneader, the norbornene-based resin is uniformly dispersed in the polyolefin resin and becomes a source of the air bubble likewise a particulate nucleating agent.

As a result, a large amount of microscopic air bubble is generated, which allows uniform growth, an outer diameter as well as capacitance become extremely stable, and it is thereby possible to manufacture a high-foaming and low-skew foam insulated wire as an objective.

### Examples

Examples of the invention and Comparative Examples will be described as follows.

Since the object of the invention is to manufacture a low-skew wire, wires were experimentally manufactured in Examples and Comparative Examples. The manufacturing conditions and the target values of the experimental wires are as shown in Table 1.

TABLE 1

| | | Conditions/ |
|---|---|---|
| Item | Unit | Target value |
| Extruder diameter | mm | 45 |
| L/D of extruder | | 29 |
| Extrusion temperature | ° C. | 160-170 |
| Type of gas | | N₂ |
| Gas pressure | MPa | 36-38 |
| Conductor diameter | AWG (mm) | 24 (0.51) |
| Type of conductor | | Tinned copper wire |
| Linear velocity | m/min | 150-180 |
| Target outer diameter | mm | 1.45 |
| Target foaming rate | % | 60 |

In addition, the details of a twin-screw kneader used in Example 2 and Comparative Example 3 are as follows.

Aperture: 40 mm, L/D: 60 A perfect match type same-direction rotary kneader

During the kneading, the rotation speed is 60 rpm, the feeding amount is 50 kg/h and the extrusion temperature is 180-220° C.

Table 2 shows Examples 1-3 and Comparative Examples 1-3.

TABLE 2

| | | | | | | Compar- | Compar- | Compar- |
|---|---|---|---|---|---|---|---|---|
| | | | | | | ative | ative | ative |
| | Type (grade, manufacturer) | | Example 1 | Example 2 | Example 3 | Example 1 | Example 2 | Example 3 |
| Mater batch | LDPE (B028, UBE-MARUZEN | | — | 9.5 | 9.2 | — | — | 9.5 |
| (Twin-screw | POLYETHYLENE Co., Ltd.) | | | | | | | |
| kneader) | Ethylene- | (TOPAS6013 (Tg138° C.), | — | 0.5 | — | — | — | — |
| | norbornene | Polyplastics Co., Ltd.) | | | | | | |
| | copolymer | (TOPAS6017 (Tg178° C.), | — | — | 0.8 | — | — | — |
| | | Polyplastics Co., Ltd.) | | | | | | |

| | | | | | | | |
|---|---|---|---|---|---|---|---|
| | Fused silica (FB-5D(5 μm in average, | — | — | — | — | — | 0.5 |
| | Denki Kagaku Kogyo Kabushiki | | | | | | |
| | Kaisha) | | | | | | |
| Main | HDPE (6944, Nippon Unicar Company | 60 | 60 | 60 | 60 | 60 | 60 |
| composition | Limited) | | | | | | |
| | LDPE (B028, UBE-MARUZEN | 39.5 | 30 | 30 | 40 | 38 | 30 |
| | POLYETHYLENE Co., Ltd.) | | | | | | |
| | Norbornene ring-opened polymer | 0.5 | — | — | — | 2.0 | — |
| | (ZEONEX, 480R (Tg 138° C.), | | | | | | |
| | Zeon Corporation) | | | | | | |
| Evaluation result | Air bubble diameter (μm) | ◯ | ◯ | ◯ | X | ◯ | X |
| | | 90 ± 20 | 80 ± 10 | 70 ± 10 | 150 ± 30 | 100 ± 20 | 100 ± 25 |
| | Foaming rate | ◯ | ◯ | ◯ | X | X | X |
| | Variation (±%) | 1.0 | 0.8 | 0.8 | 3.5 | 1.2 | 1.5 |
| | Heat distortion | ◯ | ◯ | ◯ | X | ◯ | X |
| | (%) | 15 | 12 | 10 | 30 | 15 | 20 |
| | Assessment | ◯ | ◯ | ◯ | X | X | X |

### Example 1

Example 1 is a result that the norbornene resin was directly introduced into the foam extruder.

Each pellet was introduced into the foam extruder at a mixing ratio of 0.5 parts by weight of norbornene-based resin (ZEONEX480R, manufactured by Zeon Corporation) to 60 parts by weight of HDPE (6944, manufactured by Nippon Unicar Company Limited) and 39.5 parts by weight of LDPE (B028, manufactured by UBE-MARUZEN POLYETHYLENE Co., Ltd.), thereby experimentally manufacturing a foam insulated wire.

### Example 2

Example 2 is an example of initially kneading the norbornene-based resin and LDPE in the twin-screw kneader for making a master batch (MB).

LDPE (B028, manufactured by UBE-MARUZEN POLYETHYLENE Co., Ltd.) was used as a base resin for making the MB. Pellets were mixed at a ratio of 5 parts by weight of norbornene-based resin (TOPAS6013, manufactured by Polyplastics Co., Ltd.) to 95 parts by weight of the LDPE and were kneaded in the twin-screw kneader.

The above-mentioned MB was pelletized and was introduced into the foam extruder at a mixing ratio of 60 parts by weight of HDPE (6944, manufactured by Nippon Unicar Company Limited) and 30 parts by weight of LDPE (B028, manufactured by UBE-MARUZEN POLYETHYLENE Co., Ltd.) to 10 parts by weight of the MB, thereby experimentally manufacturing a foam insulated wire.

### Example 3

Example 3 is an example in which, although a MB is made by the twin-screw kneader in the same manner as Example 2, the grade of the used norbornene resin is such that the glass transition temperature is high (178° C.) for the comparison.

LDPE (B028, manufactured by UBE-MARUZEN POLYETHYLENE Co., Ltd.) was used as a base resin for making the MB. Pellets were mixed at a ratio of 8 parts by weight of norbornene-based resin (TOPAS6017, manufactured by Polyplastics Co., Ltd.) to 92 parts by weight of the LDPE and were kneaded in the twin-screw kneader.

The above-mentioned MB was pelletized and was introduced into the foam extruder at a mixing ratio of 60 parts by weight of HDPE (6944, manufactured by Nippon Unicar Company Limited) and 30 parts by weight of LDPE (B028, manufactured by UBE-MARUZEN POLYETHYLENE Co., Ltd.) to 10 parts by weight of the MB, thereby experimentally manufacturing a foam insulated wire.

As for Comparative Examples, from a consideration of the purpose of the invention (a resin different from the base resin is added and is finely dispersed by processing at the glass transition temperature or more, and thereby allowing to work as a nucleating agent with numerous fine particles), Examples 1-3 were made in cases that, a) any nucleating agent is not added at all, b) the nucleating agent resin is added at 2 mass % to the total resin, and c) an inorganic particle nucleating agent (fused silica) is introduced into the foam extruder by the MB method.

### Comparative Example 1

In Comparative Example 1, although the material system is the same as the Examples, only PE is mixed without introducing nucleating agents.

The pellets of 60 parts by weight of HDPE (6944, manufactured by Nippon Unicar Company Limited) and 40 parts by weight of LDPE (B028, manufactured by UBE-MARUZEN POLYETHYLENE Co., Ltd.) were mixed and introduced into the foam extruder, thereby experimentally manufacturing a foam insulated wire.

### Comparative Example 2

In Comparative Example 2, although the material system is the same as the Example 1, each pellet was introduced into the foam extruder at a mixing ratio of 2 parts by weight of norbornene resin (ZEONEX, 480R, manufactured by Zeon Corporation) to 60 parts by weight of HDPE (6944, manufactured by Nippon Unicar Company Limited) and 38 parts by weight of LDPE (B028, manufactured by UBE-MARUZEN POLYETHYLENE Co., Ltd.), thereby experimentally manufacturing a foam insulated wire.

### Comparative Example 3

Comparative Example 3 was made as an example of using an inorganic particle (fused silica) nucleating agent. However, since it is known that particles are likely to be aggregated in a method of directly introducing powder of the inorganic particle into the extruder, a high-concentration mixture pellet was preliminarily made as a MB in the same manner as Example 2.

LDPE (B028, manufactured by UBE-MARUZEN POLYETHYLENE Co., Ltd.) is used as a base resin for making the MB. Materials were mixed at a ratio of 0.5 parts by weight of fused silica powder (FB-5D(particle diameter of 5 μm in average, Denki Kagaku Kogyo Kabushiki Kaisha) to 9.5 parts by weight of the LDPE and were kneaded in the twin-screw kneader.

The above-mentioned MB was pelletized and was introduced into the foam extruder at a mixing ratio of 60 parts by weight of HDPE (6944, manufactured by Nippon Unicar Company Limited) and 30 parts by weight of LDPE (B028, manufactured by UBE-MARUZEN POLYETHYLENE Co., Ltd.) to 10 parts by weight of the MB, thereby experimentally manufacturing a foam insulated wire.

### Evaluations of Examples 1-3 and Comparative Examples 1-3

Since the object of the invention is to manufacture a high-foaming and low-skew foam insulated wire, each item of air bubble diameter, stability of foaming rate and heat distortion was evaluated corresponding to the objective. In Table 2, “◯” and “×” mean “Passed” and “Not passed”, respectively, with respect to each item in the evaluation results.

Evaluation Method of the Air Bubble Diameter

Cross sections of five specimens sampled from the experimental wire taking enough intervals (1000 m or more) are photographed by SEM (SN-3000, manufactured by Hitachi High-Technologies Corporation) and a mean circle-equivalent diameter of the photographed air bubble is calculated, and then, an average value and variation of five photos are evaluated. 100 μm or less of air bubble diameter is evaluated as “Passed”.

The mean circle-equivalent diameter is calculated as follows: The SEM image is loaded using an image analyzing soft, the outline of the air bubble is specified and a dimension of the air bubble is calculated, then, a diameter assuming the dimension as circle is calculated.

Stability of Foaming Rate

Variation values of the foaming rate of portions all having the same length (10000 m) were compared from the foaming rate data during the experimental manufacture of the wire. Since the wire is manufactured so that an average foaming rate is 60%, only the variation value is shown. ±1.0% or less of variation amount is evaluated as “Passed”.

Heat Distortion Test

In order to compare the mechanical strength of the experimental wires, 10 specimens of the experimental wires cut in a length of 7 cm were horizontally arranged, a prove (a semicircular column having a diameter of 5 mm, manufactured by SUS) was placed so as to be orthogonal to the specimens, the specimens were left for 30 minutes under environment at 70° C. and 10N of load, and a transformation ratio with respect to the initial value was calculated. The capacitance and the outer diameter of the experimental wire are measured, the foaming rate at each moment is calculated from the conductor diameter, the wire diameter, the capacitance and a relative dielectric constant (ε 2.3) of the base resin, thereby deriving the transformation ratio from the degree of variation in the maximum and minimum values of the calculated foaming rate with respect to the average value, and 15% or less of transformation ratio is evaluated as “Passed”.

From Table 2, Examples 1-3 generally have: (1) a small air bubble diameter as well as small variation; (2) small and stable variation in the foaming rate; and (3) small heat distortion and excellent mechanical strength, compared with Comparative Examples 1-3.

Especially, Comparative Example 1 is large in all of the air bubble diameter, the variation in foaming rate and the heat distortion compared with Comparative Examples 2 and 3, and it is understood that it is difficult to manufacture a high performance foam insulated wire without effective foam nucleating agent.

When comparing Example 1 with Comparative Example 2, the air bubble diameter and the heat distortion are substantially equivalent, however, the variation in the foaming rate is large in Comparative Example 2. Therefore, the added amount of the foam nucleating agent is preferably 1 mass % or less.

In addition, when comparing Examples 2 and 3 with Comparative Example 3, it is understood that Examples 2 and 3 are obviously excellent in all of the three evaluated items.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A foamed resin composition, comprising:
a polyolefin-based resin; and
a ring opening polymer of norbornene or a copolymer of norbornene and ethylene or a mixture thereof,
wherein the ring opening polymer of norbornene or the copolymer of norbornene and ethylene or the mixture thereof is used as a foam nucleating agent.

2. The foamed resin composition according to claim 1, wherein the polyolefin-based resin comprises polyethylene or polypropylene or a mixture thereof.

3. The foamed resin composition according to claim 1, wherein 0.001-1 mass % of the ring opening polymer of norbornene or the copolymer of ethylene or the mixture thereof is contained per 100 mass % of the foamed resin composition.

4. A foam insulated wire, comprising:
the foamed resin composition according to claim 1 as an expanded insulation on an outer periphery of a metal conductor.

5. A foam insulated cable, comprising:
the foamed resin composition according to claim 1 as an expanded insulation on an outer periphery of a metal conductor.
